(19) United States
(12) Patent Application Publication
(10) Pub. No.: US 2025/0313473 A1
(43) Pub. Date: Oct. 9, 2025

(54) METHOD FOR PRODUCING METAL-CARBON COMPLEX AND METAL-CARBON COMPLEX PRODUCED THEREBY

(71) Applicant: UNIVERSITY-INDUSTRY COOPERATION GROUP OF KYUNG HEE UNIVERSITY, Yongin-si (KR)

(72) Inventors: Sun Ho JEONG, Yongin-si (KR); Ye Jin Jo, Anyang-si (KR)

(73) Assignee: UNIVERSITY-INDUSTRY COOPERATION GROUP OF KYUNG HEE UNIVERSITY, Yongin-si (KR)

(21) Appl. No.: 19/051,355

(22) Filed: Feb. 12, 2025

(30) Foreign Application Priority Data
Apr. 4, 2024 (KR) 10-2024-0045939

(51) Int. Cl. C01B 32/05

(52) U.S. Cl. CPC C01B 32/05; C01P 2002/72; C01P 2002/82; C01P 2002/85; C01P 2004/04; C01P 2004/80

(57) ABSTRACT

Disclosed is a method of manufacturing a carbon-metal composite, and more particularly a method of synthesizing a functional inorganic material on the surface of a carbon composite using a polymer having polar molecules and a carbon composite including a metal compound. Still more particularly, the surface of the metal compound of the carbon composite can be selectively modified using binding between a hydroxyl group, included in an oxide film included in the metal compound, and the polar molecules of the polymer. In addition, the polar molecules of the polymer can adsorb metal cations, and the polar molecules reduce the metal cations through heat treatment, thereby alloying the metal compound and the metal cations to form the composite of the carbon material and the metal alloy.

### CROSS-REFERENCE TO RELATED APPLICATION

This application claims priority to Korean Patent Application No. 10-2024-0045939, filed on Apr. 4, 2024 in the Korean Intellectual Property Office, the disclosure of which is incorporated herein by reference.

### BACKGROUND OF THE DISCLOSURE

### Field of the Disclosure

The present disclosure relates to a method of manufacturing a carbon-metal composite and a carbon-metal composite manufactured by the method, and more particularly a method of synthesizing a functional inorganic material on the surface of a carbon composite.

### Background Art

Carbon materials are highly valuable materials that are applied to various industries such as catalysts, fuel cells, secondary battery electrode materials, supercapacitors, composite materials, gas sensors, solar cells, chemical plants, desalination plants, and natural gas reformers, and are being applied in various forms.

Activated carbon, which has high conductivity, very high mechanical properties, and a very high specific surface area, is being studied extensively in the field of electrode materials for fuel cells and secondary batteries due to its high porosity and stable carbon characteristics. In addition, it is also receiving attention as a fuel gas storage material such as hydrocarbons and hydrogen, or as a separation matrix that can purify gases harmful to the human body, such as carbon dioxide in polluted areas.

Materials in which carbon materials (diamond, graphite, carbon black, carbon nanotubes, etc.) having high thermal conductivity are mixed with polymers are used as heat dissipation materials for controlling heat generation in electronic products or components. As modern electronic products become more precise, miniaturized, and highly integrated, localized heat generation becomes more severe. This heat generation not only reduces the efficiency and performance of electronic components, but also poses serious concerns about the stability of semiconductors. Therefore, the importance of heat dissipation materials to prevent these problems is becoming increasingly important.

Carbon materials are also used as electromagnetic interference-shielding materials. Electromagnetic waves are due to a phenomenon in which energy moves in a sinusoidal shape while electric and magnetic fields interact with each other. Electromagnetic waves are reflected or absorbed and extinguished when they encounter a material while traveling. This is related to the material's conductivity, dielectric properties, and magnetic properties.

Long-term exposure to strong electromagnetic waves disrupts the hormone secretion system, and children, pregnant women, and the elderly with weak immune systems are vulnerable to electromagnetic waves, so a solution to such damage is needed. In addition, as the miniaturization and thinning of electronic devices increase, the damage from electromagnetic interference (EMI) due to electromagnetic wave noise between adjacent circuits within the devices is increasing, so the need for solutions to such damage is increasing.

As discussed above, as the application forms of carbon materials diversify, the functionalization of carbon materials is receiving more attention as an important characteristic, and the development of surface modification technology that adds various functions to the surface of carbon materials is continuously required.

However, most current methods for introducing functional materials onto the surface of highly hydrophobic carbon materials use surface treatment techniques that create defects on the surface of carbon material, or have complex manufacturing processes and require high manufacturing costs. Therefore, there is a need for a surface modification method that can reduce manufacturing costs and has a simple manufacturing process.

### RELATED ART DOCUMENT

### Patent Document

Korean Patent No. 10-1656131, entitled “METHOD FOR MANUFACTURING NANOCOMPOSITE MATERIAL USING MECHANICAL ALLOYING OF GRAPHITE-METAL MATRIX COMPOSITE MATERIAL AND NANOCOMPOSITE MATERIAL BY MANUFACTURING METHOD”

### SUMMARY OF THE DISCLOSURE

Therefore, the present disclosure has been made in view of the above problems, and it is an object of the present disclosure to provide a method of manufacturing a carbon-metal composite and a carbon-metal composite manufactured by the method. More specifically, a method of introducing a functional inorganic material to the surface of a metal compound included in a carbon material is provided.

It is another object of the present disclosure to provide a surface modification method for a carbon material which is simpler than existing manufacturing methods and can reduce manufacturing costs.

In accordance with an aspect of the present disclosure, the above and other objects can be accomplished by the provision of a method of manufacturing a carbon-metal composite, the method including: preparing a carbon composite including a metal compound and a carbon material; preparing an aqueous polymer solution including a polymer having polar molecules; mixing the carbon composite with the aqueous polymer solution to prepare a carbon composite solution; forming a metal-carbon compound, in which metal ions are adsorbed on the polymer, by mixing the carbon composite solution with an aqueous metal solution; and performing a first heat treatment on the metal-carbon compound to perform a metal alloy.

According to an embodiment of the present disclosure, the metal compound may include an oxide film having a hydroxyl group.

According to an embodiment of the present disclosure, the metal alloy may be formed by reduction of the metal ions by the polar molecules.

According to an embodiment of the present disclosure, the polar molecules may include one type selected from the group consisting of a hydroxyl group, an alkoxy group, an amino group, a mercapto group, an alkylthio group, a carbonyl group, a carboxyl group, a nitrile group, and a pyridine group.

According to an embodiment of the present disclosure, in the preparing of the carbon composite solution, a weight ratio of the carbon composite to the polymer may be 1:0.01 to 1:0.5.

According to an embodiment of the present disclosure, in the forming of the metal-carbon compound, the aqueous metal solution may be at a concentration of 5 w/w % to 50 w/w %.

According to an embodiment of the present disclosure, in the performing of the heat treatment, a process temperature may be 300° C. to 1,500° C.

According to an embodiment of the present disclosure, after the performing of the first heat treatment, forming a ceramic oxide film by performing a second heat treatment may be further included.

In accordance with another aspect of the present disclosure, there is provided a carbon-metal composite, manufactured according to the method of claim 1, the carbon-metal composite including: a carbon material; and a metal alloy.

In accordance with another embodiment of the present disclosure, the metal alloy may be formed by combining the metal salt with the metal compound.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 illustrates the schematic diagram of a manufacturing method of the present disclosure;

FIG. 2 illustrates the schematic diagram of a carbon-metal composite manufactured according to the method of the present disclosure;

FIG. 3 illustrates the schematic diagram of a ceramic oxide film formed by laser treatment;

FIG. 4 illustrates a surface image of Example 1 observed by TEM;

FIG. 5 illustrates an EDS observation result of Comparative Example 2;

FIG. 6 illustrates an EDS observation result of Example 1;

FIG. 7 illustrates an EDS observation result of Example 2;

FIG. 8 illustrates an EDS observation result of Example 3;

FIG. 9 illustrates an EDS observation result of Example 4;

FIG. 10 illustrates an EDS observation result of Example 5;

FIG. 11 illustrates a Raman analysis result of the carbon composite;

FIG. 12 illustrates a Raman analysis result of Comparative Example 1;

FIG. 13 illustrates a Raman analysis result of Example 1;

FIG. 14 illustrates a Raman analysis result of Example 5;

FIG. 15 illustrates an XRD analysis result of Comparative Example 2;

FIG. 16 illustrates an XRD analysis result of Example 1; and

FIG. 17 illustrates an XRD analysis result of Example 5.

### DETAILED DESCRIPTION OF THE DISCLOSURE

The present disclosure will now be described more fully with reference to the accompanying drawings and contents disclosed in the drawings. However, the present disclosure should not be construed as limited to the exemplary embodiments described herein.

The terms used in the present specification are used to explain a specific exemplary embodiment and not to limit the present inventive concept. Thus, the expression of singularity in the present specification includes the expression of plurality unless clearly specified otherwise in context. It will be further understood that the terms “comprise” and/or “comprising”, when used in this specification, specify the presence of stated components, steps, operations, and/or elements, but do not preclude the presence or addition of one or more other components, steps, operations, and/or elements thereof.

It should not be understood that arbitrary aspects or designs disclosed in “embodiments”, “examples”, “aspects”, etc. used in the specification are more satisfactory or advantageous than other aspects or designs.

In addition, the expression “or” means “inclusive or” rather than “exclusive or”. That is, unless otherwise mentioned or clearly inferred from context, the expression “x uses a or b” means any one of natural inclusive permutations.

In addition, as used in the description of the disclosure and the appended claims, the singular forms “a”, “an” and “the” are intended to include the plural forms as well, unless context clearly indicates otherwise.

In addition, when an element such as a layer, a film, a region, and a constituent is referred to as being “on” another element, the element can be directly on another element or an intervening element can be present.

Hereinafter, embodiments of the present disclosure are described in detail with reference to the accompanying drawings.

A method of manufacturing a carbon-metal composite according to an embodiment of the present disclosure includes a step of preparing a carbon composite including a metal compound and a carbon material; a step of preparing an aqueous polymer solution including a polymer having polar molecules; a step of mixing the carbon composite with the aqueous polymer solution to prepare a carbon composite solution; a step of mixing the carbon composite solution with an aqueous metal solution to form a metal-carbon compound in which metal ions are adsorbed on the polymer; and a step of performing a first heat treatment on the metal-carbon compound to perform a metal alloy. FIG. 1 illustrates the schematic diagram of the manufacturing method of the present disclosure.

The carbon material included in the carbon composite may be one selected from the group consisting of graphene, graphene oxide, graphene nanoribbon (GNR), graphene nanoplatelet, carbon nanotubes, carbon nanofiber, graphite, and expanded graphite, but the present disclosure is not limited to the materials.

The metal compound included in the carbon composite may be at least one selected from the group consisting of iron (Fe), iron carbide (Fe₃C), iron oxide (Fe₂O₃, Fe₃O₄), nickel (Ni), nickel carbide (NiC) and nickel oxide (NiO, Ni₂O).

In the present disclosure, the metal compound is characterized by including an oxide film having a hydroxyl group.

The surface of the metal compound included in the carbon material naturally undergoes an oxidation reaction when exposed to the air, having an oxide film. This oxide film is characterized by having a hydroxyl group. In general, hydrophobic carbon surfaces have the difficulty of not being surface-modified, but in the case of a carbon composite containing a metal compound, the hydroxyl group of the metal compound can act as an active site for a surface-modification reaction that gives various physical properties to the carbon material.

The present disclosure proposes a surface modification method capable of introducing a functional material to the surface of a carbon composite using a hydroxyl group included in an oxide film of a metal compound, and a polymer having polar molecules. More specifically, a method of selectively modifying the surface of a carbon composite by adsorbing a polymer on the surface of a metal compound in the carbon composite is proposed. The polymer adsorbed on the metal compound may act as a medium capable of introducing a metal alloy or a functional inorganic material such as ceramic to the surface of the carbon composite.

The metal alloy formed according to the manufacturing method of the present disclosure is characterized in that the metal ions are reduced and formed by the polar molecules of the polymer.

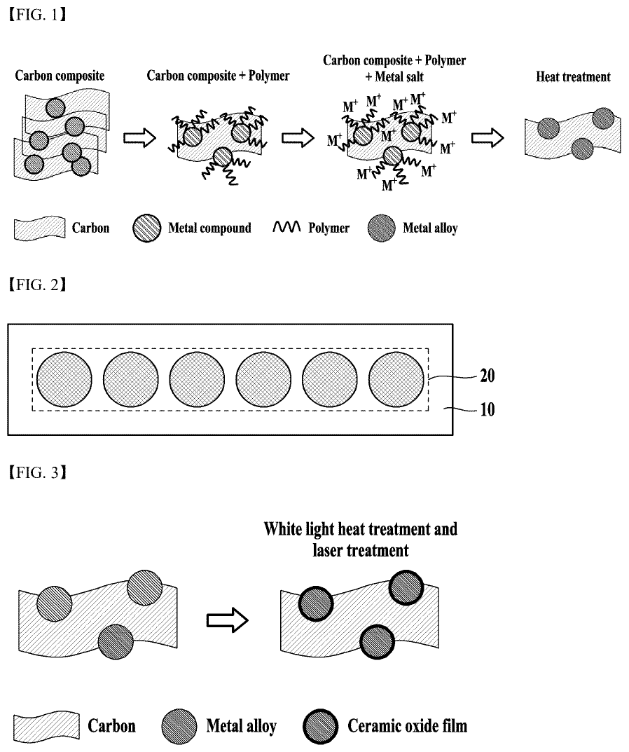

In the step of preparing a carbon composite solution, the polar molecules of the polymer may form a physical bond with a hydroxyl group of the metal compound included in the carbon composite, and may exist in a form adsorbed on the surface of the metal compound. Next, when mixed with an aqueous metal solution, a metal-carbon compound where the polar molecules of the polymer and the metal ions included in the aqueous metal solution are adsorbed is formed, and the metal ions are combined with the metal compound, included in the carbon composite, by a reduction reaction due to the polar molecules of the polymer through a heat treatment step, thereby forming a metal alloy. FIG. 2 illustrates the schematic diagram of the carbon-metal composite of the present disclosure where a metal alloy is formed.

In the present disclosure, the polar molecules in the polymer may be one type selected from the group consisting of a hydroxyl group, an alkoxy group, an amino group, a mercapto group, an alkylthio group, a carbonyl group, a carboxyl group, a nitrile group, and a pyridine group.

Specific examples of the polymer having polar molecules include polyethyleneimine, polypyrrolidone, poly(acrylic acid), carboxymethylcellulose, and the like, but are not limited thereto.

Hereinafter, the manufacturing process of the present disclosure is described step by step.

In the step of preparing a carbon composite solution, a carbon composite solution is prepared by stirring a polymer solution and a carbon composite. The stirring may be done by using a magnetic bar or ultrasonic stirring, and a weight ratio of the carbon composite to the polymer is characterized by being 1:0.01 to 1:0.5.

In the weight ratio of the carbon composite to the polymer, when the proportion of the polymer is less than 0.01, the proportion of the polymer adsorbed on the surface of the carbon composite is limited, so that an adsorption area density may be reduced. When the proportion of the polymer exceeds 0.5, a polymer and metal salts which are not adsorbed on the surface of the carbon composite may not be separated and may precipitate.

The concentration of the polymer solution may be 0.001 w/w % to 0.1 w/w %. When the concentration of the polymer solution is less than 0.001 w/w %, the behavior of the polymer adsorbing on the surface of the carbon composite is limited, so that an adsorption area density may be reduced. When the concentration of the polymer solution exceeds 0.1 w/w %, a uniform adsorption reaction may be limited due to a physical bond between the polymer particles.

A preferred stirring temperature is 10° C. to 60° C. When the stirring temperature is lower than 10° C., the adsorption reaction of the polymer may not be sufficiently activated. When the stirring temperature is higher than 60° C., the adsorption reaction of the polymer may not proceed uniformly on the carbon composite surface due to high thermal energy.

A preferred stirring speed is 100 rpm to 500 rpm. When the stirring speed is less than 100 rpm, the homogeneous adsorption reaction of the polymer may be inhibited. When the stirring speed exceeds 500 rpm, the adsorption density of the polymer on the surface of the carbon composite may be reduced.

A preferred stirring time is 30 minutes to 180 minutes. When the stirring time is less than 30 minutes, sufficient adsorption of the polymer does not occur. When the stirring time is 180 minutes or more, the polymer adsorption layer may be detached.

The step of forming a metal-carbon compound is carried out by mixing and stirring the carbon composite solution with the aqueous metal solution including the metal salt.

The metal salt may be one selected from the group consisting of nickel chloride hexahydrate, nickel sulfate hexahydrate, nickel nitrate hexahydrate, copper sulfate pentahydrate, copper nitrate trihydrate, cobalt carbonate hydrate, cobalt nitrate hexahydrate, aluminum nitrate nonahydrate, zirconium acetate, magnesium sulfate and cerium nitrate hexahydrate, and electrical conductivity, magnetic properties, dielectric properties, and mechanical properties may be controlled depending on the composition of metal and ceramic to be adsorbed.

The concentration of the aqueous metal solution is characterized by being 5 w/w % to 50 w/w %. When the concentration of the aqueous metal salt solution is less than 5% by weight, a metal salt surface density decreases because the behavior of the metal salt binding to the polymer is stochastically limited. When the concentration of the aqueous metal salt solution exceeds 50%, a precipitate may be generated due to the hydration reaction of the metal salt.

In the step of forming a metal-carbon compound, the stirring temperature is preferably 10° C. to 60° C. When the stirring temperature is less than 10° C., the adsorption reaction of the metal salt may not be sufficiently activated. When the stirring temperature is higher than 60° C., a precipitate may be generated due to the activation of the hydration reaction of the metal salt.

The stirring speed is preferably 100 rpm to 500 rpm. When the stirring speed is less than 100 rpm, the homogeneous adsorption reaction of the metal salt may be inhibited. When the stirring speed exceeds 500 rpm, the adsorption density of the metal salt may be reduced.

The stirring time is preferably 30 minutes to 180 minutes. When the stirring time is less than 30 minutes, sufficient adsorption of the metal salt may not occur. When the stirring time exceeds 180 minutes, desorption of the metal salt may occur.

In the step of forming a metal alloy, the prepared metal-carbon compound is subjected to a first heat treatment to reduce metal cations by the polar molecules of the polymer, thereby forming a metal alloy. electrical conductivity and magnetic properties may be imparted to the carbon material by forming a metal alloy on the surface of the metal-carbon compound.

The first heat treatment may be one selected from the group consisting of heating heat treatment and plasma heat treatment, and the heating heat treatment may include Joule heating and microwave heating. Here, “Joule heating” is also called resistance heating and refers to a method of utilizing heat generated by friction at the molecular level when current flows through an object, and “microwave heating” refers to a method of heating a sample using the dielectric resonance of microwaves.

In the first heat treatment step, the process temperature is preferably 300° C. to 1,500° C. When the process temperature is less than 300° C., the thermal decomposition reaction of the metal salt does not sufficiently proceed, so an alloy may not be formed. When the process temperature is higher than 1,500° C., the shape of the alloy may not be maintained due to the melting of the metal.

In the present disclosure, a step of performing a second heat treatment to form a ceramic oxide film may be further included after the step of performing the first heat treatment. The second heat treatment may include one selected from the group consisting of white light heat treatment and laser heat treatment. The white light heat treatment means irradiating with one or more light of ultraviolet and visible light, and the laser heat treatment means irradiating with at least one of ultraviolet, visible, near-infrared, and mid-infrared light. A ceramic oxide film may be further formed on the surface of the metal alloy through white light and laser treatment.

In the step of forming a metal alloy, an oxidation reaction is suppressed because heat treatment is performed in an inert atmosphere. However, since white light heat treatment and laser treatment are performed within a short time in a general atmosphere, a ceramic oxide film may be partially formed on the surface. FIG. 3 illustrates the schematic diagram of a ceramic oxide film formed by white light heat treatment and laser treatment. When the ceramic oxide film is formed through white light heat treatment and laser treatment, dielectric properties, magnetic properties and mechanical properties may be enhanced.

In the present disclosure, the surface of a carbon material may be modified only through a stirring process. Accordingly, a simpler modification method than existing carbon material modification methods may be provided, the manufacturing time may be shortened and the manufacturing cost may be reduced. In addition, since the present disclosure uses water which is an eco-friendly solvent, it has the advantage of enabling an eco-friendly process.

The carbon-metal composite of the present disclosure is manufactured by selectively synthesizing functional materials such as an alloy and a ceramic on the surface of the carbon material, so that a carbon material with high conductivity and a functional material with excellent electromagnetic properties and mechanical properties exist simultaneously on the surface of the composite, and thus, compared to a core/shell structure composite, simultaneous control of electrical properties, dielectric properties, magnetic properties, and mechanical properties is possible.

According to the above-described manufacturing method, the present disclosure may synthesize a carbon-metal composite including a carbon material and a metal alloy.

According to the method of the present disclosure, a metal alloy or a ceramic may be selectively synthesized on the surface of the carbon material. More specifically, a selective modification method of adsorbing a polymer on the surface of a metal compound of a carbon composite may be proposed by using the carbon composite including the metal compound, and the polymer having polar molecules.

In addition, after adsorbing the polymer having polar molecules on the surface of the metal compound, the metal salt is adsorbed with the polar molecules, and the first heat treatment is performed, thereby forming a metal alloy in which the metal salt and the metal compound are combined. Here, the magnetic properties, dielectric properties, and mechanical properties may be controlled by controlling the type of the combined metal salt.

An additional ceramic oxide film may be further formed on the surface of the metal alloy by performing the second heat treatment after forming the metal alloy.

When introducing the metal alloy, the electrical conductivity and magnetic properties may be controlled according to the alloy composition, and the dielectric properties and mechanical properties may be strengthened by additionally forming a ceramic oxide film.

Hereinafter, the present disclosure will be described in more detail through examples. These examples are intended to explain the present disclosure in more detail, and the scope of the present disclosure is not limited by these examples.

### Comparative Example 1

0.05 g of a carbon composite was added to a solution obtained by dissolving 0.014 g of polyethyleneimine (PEI, Mw 1,300) in 15 g of distilled water to prepare a carbon composite solution. Here, the carbon composite was prepared by mechanically milling a Fe/Fe₃C/graphite composite material. 20 g of nickel chloride hexahydrate was dissolved in 35 g of distilled water to prepare a nickel chloride solution. The nickel chloride solution was added to the carbon composite solution and stirred for 1 hour to allow adsorption. A precipitate was obtained by centrifuging at 6000 rpm for 10 minutes. The precipitate was dried at 80° C. to manufacture Comparative Example 1.

### Comparative Example 2

Comparative Example 2 was manufactured in the same manner as in Comparative Example 1 except that polyethylene imine was not used, and a process of heat-treating a dried precipitate at 800° C. for 3 hours in an Ar atmosphere was added.

### Example 1

0.05 g of a carbon composite was added to a solution obtained by dissolving 0.014 g of polyethyleneimine (PEI, Mw 1,300) in 15 g of distilled water to prepare a carbon composite solution. 20 g of nickel chloride hexahydrate was dissolved in 35 g of distilled water to prepare a nickel chloride solution. The nickel chloride solution was added to the carbon composite solution and stirred for 1 hour to allow adsorption. A precipitate was obtained by centrifuging at 6000 rpm for 10 minutes. The precipitate was dried at 80° C., and the dried precipitate was heat-treated at 800° C. for 3 hours in an Ar atmosphere, thereby manufacturing Example 1.

### Example 2

Example 2 was manufactured in the same manner as in Example 1 except that 0.0008 g of polypyrrolidone (Mw 10,000) was used instead of Example 1.

### Example 3

Example 3 was manufactured in the same manner as in Example 1 except that 0.0017 g of poly(acrylic acid) (Mw 450,000) was used instead of polyethyleneimine.

### Example 4

Example 4 was manufactured in the same manner as in Example 1 except that 0.0025 g of carboxymethyl cellulose (substitution degree: 0.9) was used instead of polyethyleneimine.

### Example 5

Example 5 was manufactured by irradiating Example 1 with a laser having a power of 3.7 W at a speed of 400 mm/sec under normal atmosphere conditions with oxygen.

### <Observation of Transmission Electron Microscope (TEM) Image of Carbon-Metal Composite>

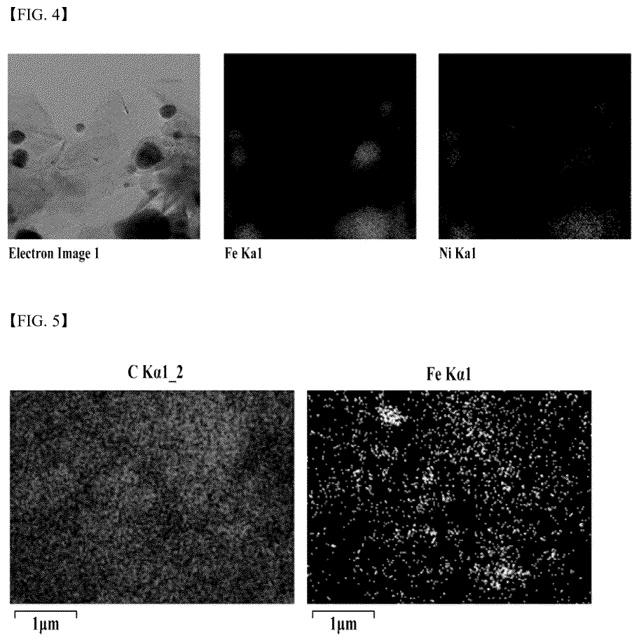

TEM was used to observe the structure of Example 1. Results are shown in FIG. 4. Referring to the result of FIG. 4, it can be confirmed that the metal alloy is partially formed on the surface of the carbon composite, and the metal alloy is formed in the part where iron, iron oxide and iron carbide included in the carbon composite are located.

From this, the method of the present disclosure may introduce a functional inorganic material such as a metal alloy or a ceramic on the carbon surface, and may locally syntheize a functional material on the carbon surface.

### <Energy Dispersive Spectroscopy (EDS) of Carbon-Metal Composites>

TABLE 1

| | Comparative | | | | | |
|---|---|---|---|---|---|---|
| | Example 2 | Example 1 | Example 2 | Example 3 | Example 4 | Example 5 |
| | Element % | Element % | Element % | Element % | Element % | Element % |
| Classification | (at %) | (at %) | (at %) | (at %) | (at %) | (at %) |
| Carbon (C) | 98.9 | 96.0 | 96.4 | 98.2 | 94.9 | 97.6 |
| Iron (Fe) | 1.1 | 2.2 | 2.7 | 1.3 | 3.4 | 1.5 |
| Nickel (Ni) | — | 1.7 | 0.9 | 0.5 | 1.7 | 0.9 |
| Iron:Nickel | | 56:44 | 76:24 | 73:27 | 67:33 | 61:39 |

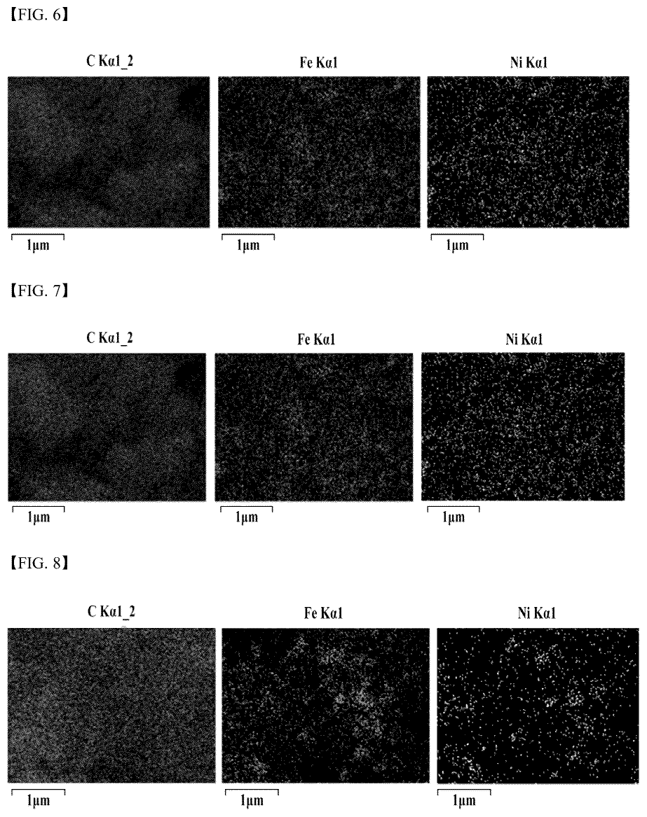

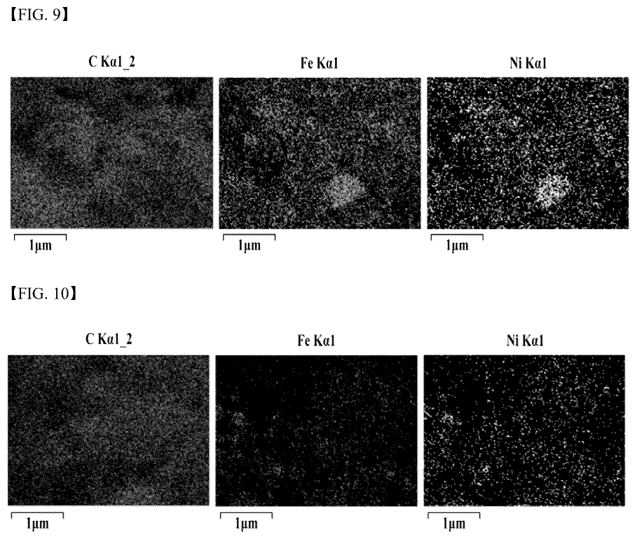

The EDS analysis results of Comparative Example 2 and Examples 1 to 5 are illustrated in Table 1 and FIGS. 5 to 10.

It can be confirmed that, in the case of Examples 1 to 5 in which the polymer having polar molecules is used, a nickel metal is successfully alloyed, unlike Comparative Example 2 in which the polymer is not used. It can be confirmed that, in the case of Comparative Example 2 excluding the polymer, nickel was not contained in the final product as shown in Table 1. From this, it can be seen that a functional inorganic material cannot be introduced only with the carbon composite including the metal compound.

On the other hand, it can be seen that, in the case of Examples 1 to 5 using the polymer having various polar molecules, nickel is contained in the final product, the carbon-metal composite, and the content of nickel differs depending on the type of the polar molecules. Accordingly, it can be seen that the introduction amount and properties of the functional inorganic material can be controlled by controlling the type of the polar molecules.

It can be seen that, in the case of Example 5 in which polyethyleneimine was used as a polymer and laser treatment was added, the proportion of iron in the metal alloy increases, compared to Example 1 where laser treatment was not conducted. Comparing the results of Examples 1 and 5 using the same materials with each other, the metal proportions in the alloys vary depending on the presence or absence of laser treatment even though the same materials were used. From this, it can be inferred that the properties can be controlled by laser treatment.

### <Raman Analysis of Carbon-Metal Composites>

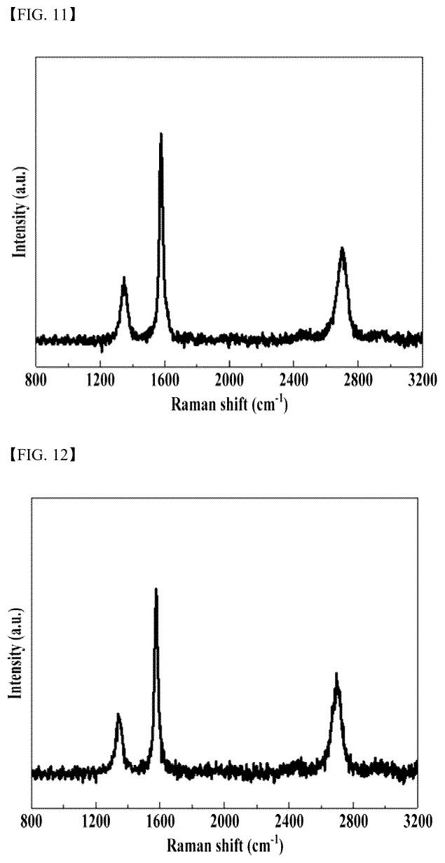

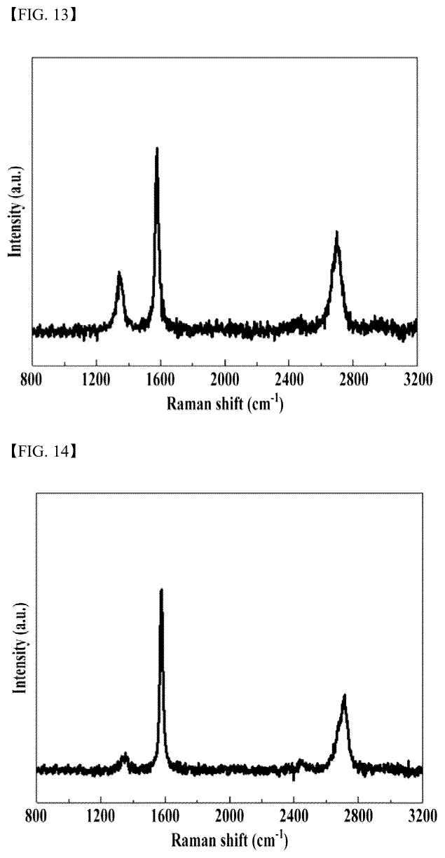

FIGS. 11 to 14 illustrate the Raman analysis results of the carbon composite, Comparative Example 1, Example 1, and Example 5, respectively. Referring to the results of FIGS. 11 to 14, peaks are observed at 1350, 1580, and 2680, the 1350 peak indicates carbon defects, the 1580 peak indicates grapheneization, and the 2680 peak is changed according to the thickness of the film.

It can be seen from the 1350 peaks of FIGS. 11 to 13 that the Fe/Fe₃C/graphite material, a carbon composite, used in the present disclosure, has carbon defects, and the carbon defects still remain even in Comparative Example 1 where the polymer having polar molecules is adsorbed, and Example 1 where a metal alloy is formed by heat treatment.

In the case of Example 5 which was subjected to laser treatment, the 1350 peak indicating carbon defects was reduced. From this, it can be seen that energy is absorbed and the temperature increases when irradiated with laser, so grapheneization further progresses and, thus, carbon defects are reduced.

### <X-Ray Diffraction (XRD) Analysis Results of Carbon-Metal Composites>

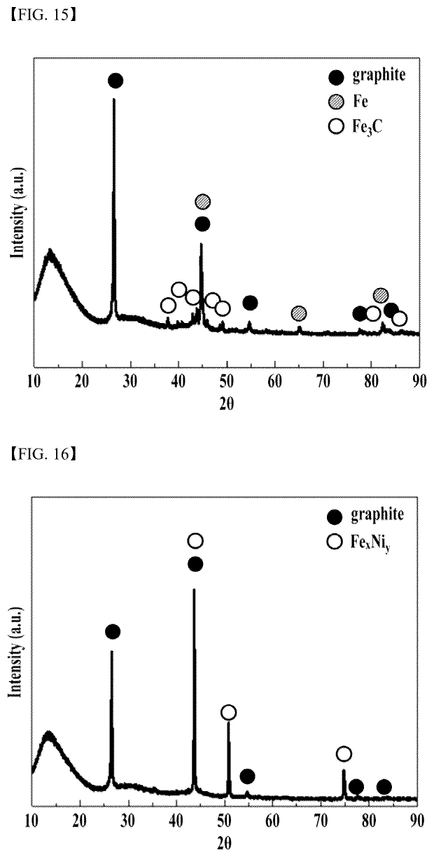

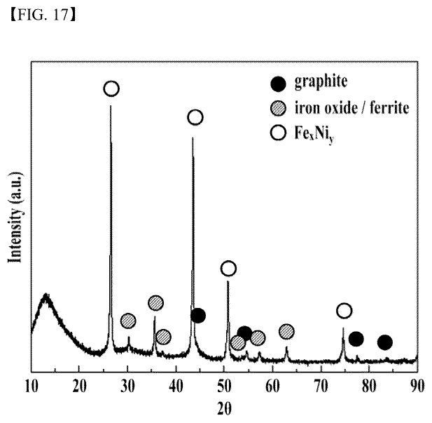

FIGS. 15 to 17 illustrate the XRD analysis results of Comparative Example 2, Example 1 and Example 5, respectively. It can be confirmed that an iron-nickel alloy was not formed in FIG. 15 showing the result of Comparative Example 2 where a polymer was not used. In addition, it can be seen that, in FIGS. 16 and 17 showing the results of Examples 1 and 5, the peaks of iron and iron carbide are reduced, and the peak of the iron-nickel alloy is newly generated.

In addition, it can be confirmed that, in the case of FIG. 17 where laser treatment was additionally performed, an iron oxide peak and a ferrite peak were additionally generated unlike FIG. 16 where laser treatment was not performed. This means that the oxidation reaction of the alloy is further advanced by laser treatment, and ceramic is formed on the surface of the alloy.

From the specific results described above, it can be seen that, by using the carbon composite containing the metal compound and the polymer having polar molecules according to the manufacturing method of the present disclosure, the surface of the carbon composite can be selectively modified, a metal alloy can be synthesized on the surface of the carbon material, and a ceramic oxide film can be further formed on the surface of the metal alloy through additional laser treatment.

In the present disclosure, a method of introducing a functional inorganic material onto the surface of a carbon composite using a carbon composite including a metal compound; and a polymer having polar molecules may be proposed. Specifically, a functional inorganic material can be introduced onto the surface of the metal compound included in the carbon composite through binding between a hydroxyl group included in the metal compound and the polar polymer.

The carbon-metal composite of the present disclosure is manufactured by selectively synthesizing a functional material such as a metal alloy and ceramic on the surface of the carbon material, so that the carbon material having high conductivity and the functional material having excellent electromagnetic properties and mechanical properties simultaneously exist on the surface of the composite. Accordingly, electrical properties, dielectric properties, magnetic properties and mechanical properties can be simultaneously controlled.

Since the present disclosure further includes a step of performing first heat treatment to form a metal alloy, and a step of performing second heat treatment after forming the metal alloy, a ceramic oxide film may be further formed on the surface of the metal alloy. Through this process, magnetic properties, dielectric properties and mechanical properties can be enhanced.

Since the present disclosure uses water as an environmentally friendly solvent, it has the advantage of being an environmentally friendly process.

The method of modifying the surface of the carbon composite of the present disclosure by stirring can shorten the manufacturing time and reduce the manufacturing cost, compared to an existing method of modifying a carbon material.

Although the present disclosure has been described through limited examples and drawings, the present disclosure is not intended to be limited to the examples. Those skilled in the art will appreciate that various modifications, additions and substitutions are possible, without departing from the scope and spirit of the disclosure. Therefore, the scope of the present disclosure should not be limited to the described examples, but should be defined not only by the claims described below but also by equivalents of these claims.

### DESCRIPTION OF SYMBOLS

10: carbon material
20: metal alloy

What is claimed is:

1. A method of manufacturing a carbon-metal composite, the method comprising:
preparing a carbon composite comprising a metal compound and a carbon material;
preparing an aqueous polymer solution comprising a polymer having polar molecules;
mixing the carbon composite with the aqueous polymer solution to prepare a carbon composite solution;
forming a metal-carbon compound, in which metal ions are adsorbed on the polymer, by mixing the carbon composite solution with an aqueous metal solution; and
performing a first heat treatment on the metal-carbon compound to perform a metal alloy.

2. The method according to claim 1, wherein the metal compound comprises an oxide film having a hydroxyl group.

3. The method according to claim 1, wherein the metal alloy is formed by reduction of the metal ions by the polar molecules.

4. The method according to claim 1, wherein the polar molecules comprise one type selected from the group consisting of a hydroxyl group, an alkoxy group, an amino group, a mercapto group, an alkylthio group, a carbonyl group, a carboxyl group, a nitrile group, and a pyridine group.

5. The method according to claim 1, wherein, in the preparing of the carbon composite solution, a weight ratio of the carbon composite to the polymer is 1:0.01 to 1:0.5.

6. The method according to claim 1, wherein, in the forming of the metal-carbon compound, the aqueous metal solution is at a concentration of 5 w/w % to 50 w/w %.

7. The method according to claim 1, wherein, in the performing of the heat treatment, a process temperature is 300° C. to 1,500° C.

8. The method according to claim 1, wherein, after the performing of the first heat treatment, forming a ceramic oxide film by performing a second heat treatment is further comprised.

9. A carbon-metal composite, manufactured according to the method of claim 1, the carbon-metal composite comprising:
a carbon material; and
a metal alloy.

10. The carbon-metal composite according to claim 9, wherein the metal alloy is formed by combining the metal salt with the metal compound.
